(19) United States
(12) Patent Application Publication
(10) Pub. No.: US 2019/0373249 A1
(43) Pub. Date: Dec. 5, 2019

(54) STEREOSCOPIC DISPLAY DEVICE AND HEAD-UP DISPLAY

(71) Applicant: Mitsubishi Electric Corporation, Tokyo (JP)

(72) Inventors: Kiyotaka KATO, Tokyo (JP); Shuhei OTA, Tokyo (JP)

(73) Assignee: Mitsubishi Electric Corporation, Tokyo (JP)

(21) Appl. No.: 16/477,726

(22) PCT Filed: Feb. 6, 2017
(86) PCT No.: PCT/JP2017/004196

§ 371 Date: Jul. 12, 2019

(51) Int. Cl. H04N 13/31; G02B 27/01; B60K 35/00

(52) U.S. Cl. CPC H04N 13/31; G02B 27/0101; B60K 35/00; G02B 2027/0161; G02B 2027/0129; G02B 2027/0134; G02B 27/0149

(57) ABSTRACT

A display control unit (4) causes a display unit (5a) to display a stereoscopic image in which an image, in which a right-eye pixel (201Rpix) and a left-eye pixel (201Lpix) are periodically arrayed in the horizontal direction, is arrayed in every two rows in the vertical direction. An image separating unit (5b) separates the stereoscopic image into right-eye pixels (201aR) and left-eye pixels (201aL) at a separation angle θ0 and also into right-eye pixels (201bR) and left-eye pixels (201bL) at a separation angle θ1.

### TECHNICAL FIELD

The present invention relates to a stereoscopic display device and a head-up display for displaying stereoscopic images.

### BACKGROUND ART

There is known a technology of superimposing an image, depicting auxiliary information for assisting driving, as a virtual image on a foreground as viewed from a driver onboard a vehicle, such as head-up displays (hereinafter referred to as “HUDs”). Moreover, display devices for changing the display distance of a virtual image as viewed by a driver by changing the parallax amount between a left-eye virtual image and a right-c) e virtual image by using the principles of stereoscopic vision, such as binocular parallax are disclosed. In such a display device, by arranging a barrier or a lens for selectively blocking light in front of a display device such as a liquid crystal display, a driver is caused to visually recognize a stereoscopic image with his/her left eye caused to visually recognize only a left-eye image and with his/her right eye caused to visually recognize only a right-eye image (see, for example, Patent Literature 1).

### CITATION LIST

### Patent Literature

Patent Literature 1: JP H7-144578 A

### SUMMARY OF INVENTION

### Technical Problem

Since conventional display devices are configured as described above, there is a disadvantage in that an area in which an observer can visually recognize a stereoscopic image is fixed by the arrangement distance between the display device and the barrier, and the slit width and the slit position of the barrier or the like. Therefore, when the visual point position of the observer moves and deviates from the area where the stereoscopic image can be visually recognized, crosstalk or the like occurs, which prevents the stereoscopic image from being normally, visually recognized.

The present invention has been made to solve the disadvantage as described above, and it is an object of the present invention to expand the area where an observer can visually recognize a stereoscopic image.

### Solution to Problem

A stereoscopic display device according to the present invention includes: an image generating unit for generating a stereoscopic image by arraying an image, in which a right-eye image and a left-eye image are periodically arrayed in one direction, in every n rows in a direction perpendicular to the direction, where n is an integer equal to or larger than two; a display control unit for causing a display unit to display the stereoscopic image generated by the image generating unit; and an image separating unit for separating the stereoscopic image displayed by the display unit into n sets of right-eye images and left-eye images at n separation angles.

### Advantageous Effects of Invention

According to the present invention, since a stereoscopic image displayed by the display unit is separated into n sets of right-eye images and left-eye images at n separation angles, the number of areas where an observer can visually recognize the stereoscopic image increases to n.

### BRIEF DESCRIPTION OF DRAWINGS

FIG. 1 is a block diagram illustrating an exemplary configuration of a stereoscopic display device according to a first embodiment of the invention.

FIG. 2 is a diagram illustrating an example in which the stereoscopic display device according to the first embodiment of the present invention is mounted in a vehicle.

FIG. 3A is a structural diagram of a display unit and an image separating unit of a lenticular lens system that enables standard autostereoscopic vision.

FIG. 3B is a structural diagram of the display unit and the image separating unit of the lenticular lens system that enables standard autostereoscopic vision.

FIG. 3C is a structural diagram of the image separating unit of the lenticular lens system that enables standard autostereoscopic vision.

FIG. 4A is a diagram illustrating a standard stereoscopic visual recognition area of a HUD utilizing binocular parallax.

FIG. 4B is a diagram illustrating a standard stereoscopic visual recognition area of the HUD utilizing binocular parallax.

FIG. 5A is a structural diagram of a display unit and an image separating unit of the stereoscopic display device according to the first embodiment of the present invention.

FIG. 5B is a structural diagram of a display unit and an image separating unit of the stereoscopic display device according to the first embodiment of the present invention.

FIG. 5C is a structural diagram of an image separating unit of the stereoscopic display device according to the first embodiment of the present invention.

FIG. 6 is a diagram illustrating a stereoscopic visual recognition area of the stereoscopic display device according to the first embodiment of the present invention.

FIGS. 7A and 7B are diagrams illustrating modifications of the image separating unit 5b according to the first embodiment of the present invention.

FIG. 8 is a flowchart illustrating exemplary operation of a stereoscopic display device according to a second embodiment of the invention.

FIGS. 9A, 9B, and 9C are diagrams and a table for explaining the operation of a display control unit of the second embodiment of the present invention.

FIG. 10A and FIG. 10B are diagrams for explaining the relationship between visual point positions and stereoscopic visual, recognition areas according to the second embodiment of the present invention.

FIG. 11 is a structural diagram of an image separating unit of a stereoscopic display device according to a third embodiment of the present invention.

FIGS. 12A and 12B are a diagram and a table for explaining the operation of a display control unit of the third embodiment of the present invention.

FIG. 13 is a structural diagram of an image separating unit including a parallax barrier n a stereoscopic display device according to a fourth embodiment of the present invention.

FIG. 14A and FIG. 14B are main hardware configuration diagrams of the stereoscopic display devices and peripheral devices thereof according to the respective embodiments of the present invention.

### DESCRIPTION OF EMBODIMENTS

To describe the present invention further in detail, embodiments for carrying out the present invention will be described below with reference to the accompanying drawings.

### First Embodiment

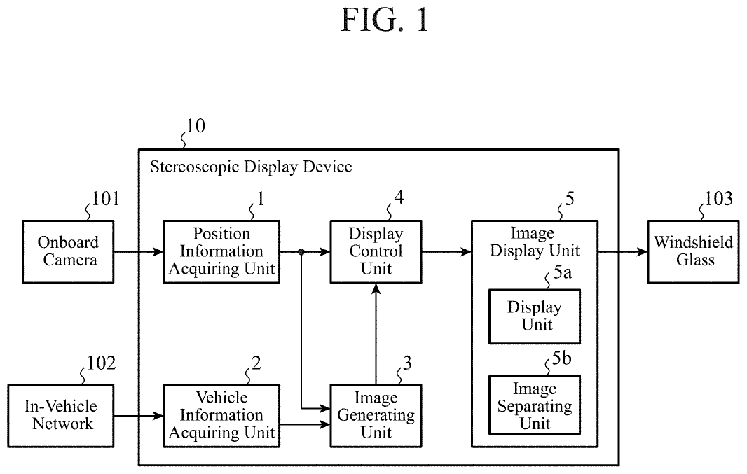

FIG. 1 is a block diagram illustrating an exemplary configuration of a stereoscopic display device 10 according to a first embodiment of the invention. In FIG. 1, the stereoscopic display device 10 according to the first embodiment includes a position information acquiring unit 1, a vehicle information acquiring unit 2, an image generating unit 3, a display control unit 4, and an image display unit 5. The stereoscopic display device 10 is mounted on, for example, a vehicle 100 which will be described later and is used as a HUD.

The position information acquiring unit 1 acquires position information indicating the visual point position of a driver from an onboard camera 101, and outputs the position information to the image generating unit 3 and the display control unit 4. A visual point position of the driver refers to, for example, the position of the eyes or the position of the head of the driver.

The vehicle information acquiring unit 2 acquires vehicle information of the vehicle 100 via an in-vehicle network 102 and outputs the vehicle information to the image generating unit 3. The vehicle information includes, for example, position information of the host vehicle, the traveling direction, the vehicle speed, the steering angle, the acceleration, time, warning information, various control signals, navigation information, and the like. The various control signals include, for example, on/off signals of the wiper, lighting signals of a light shift position signals, and the like. The navigation information includes, for example, congestion information, facility names, guidance, routes, and the like.

The image generating unit 3 generates a display image from the position information acquired by the position information acquiring unit 1 and the vehicle information acquired by the vehicle information acquiring unit 2, and outputs the display image to the display control unit 4. The display image includes a stereoscopic mage representing, for example, navigation contents such as an arrow guidance and remaining distance information, and the vehicle speed and warning information, and the like. The stereoscopic image includes images for the right eye and the left eye for stereoscopic vision. Note that the display image may include a two-dimensional image without parallax.

The display control unit 4 causes the image display unit 5 to display the display image generated by the image generating unit 3. Note that in the first embodiment, the display control unit 4 does not use the position information acquired by the position information acquiring unit 1. The example in which the display control unit 4 uses the position information will be described in a second embodiment which will be described later.

In accordance with the display control by the display control unit 4 the image display unit 5 separates the stereoscopic image generated by the image generating unit 3 into a right-eye image and a left-eye image and projects the separated images onto a windshield glass 103.

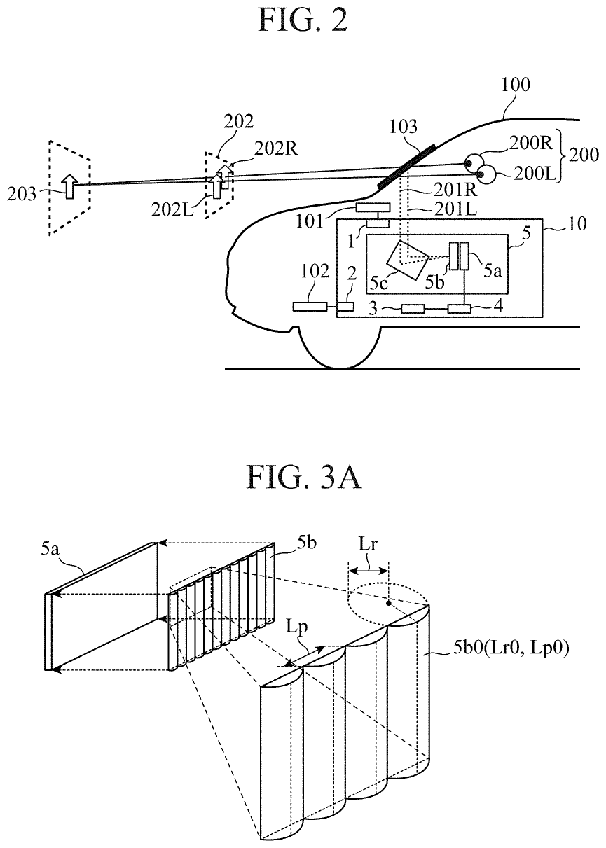

FIG. 2 is a diagram illustrating an example in which the stereoscopic display device 10 according, to the first embodiment of the present invention is mounted in a vehicle. In FIG. 2, the image display unit 5 includes a display unit 5a, an image separating unit 5h, and a reflection glass 5c. The display unit 5a is a display device such as a liquid crystal display (LCD), an organic electro-luminescence display (OELD), and a digital light processing (DLP), and displays the display image in accordance with a display control by the display control unit 4. The image separating unit 5b separates the stereoscopic image displayed by the display unit 5a into a right-eye image 2018 and a left-eye image 201L. The reflection glass 5c performs optical distortion correction and enlargement on the right-eye image 2018 and the left-eye image 201L separated by the image separating unit 5b, and projects the images onto the windshield glass 103.

The onboard camera 101 is installed at a place where a visual point position 200 of the driver can be acquired, in the vicinity of instruments such as the instrument panel or in the vicinity of a center display, a rearview mirror, or the like. The onboard camera 101 captures and analyzes a face image, detects the position of the eyes or the head, and outputs position information to the position information acquiring unit 1. Note that the onboard camera 101 may detect the position of the eyes or the head using well-known techniques such as triangulation using a stereo camera or the time of flight (TOF) using a monocular camera.

Note that the detection of the position of the eyes or the head may be performed by the onboard camera 101 or by the position information acquiring unit 1.

The in-vehicle network 102 is a network for transmitting and receiving information of the vehicle 100, such as the vehicle speed and the steering angle, between electronic control units (ECUs) mounted in the vehicle 100.

The windshield glass 103 is a projected unit on which a display image from the stereoscopic display device 10 is projected. Since the HUD of the first embodiment is of a windshield type, the projected unit is the windshield glass 103. In the case of a combiner type HUD, the projected unit is a combiner.

Next, the operation of the HUD will be described.

In FIG. 2, the stereoscopic image output from the display control unit 4 is displayed on the display unit 5a. Then, the image separating unit 5b separates the stereoscopic image displayed on the display unit 5a into the right-eye image 201R and the left-eye image 201L such that the stereoscopic image reaches a right-eye visual point 200R and a left-eye visual point 200L of the driver. Then, the reflection glass 5c performs distortion correction on, the right-eye image 201R and the left-eye image 201L in accordance with the shape of the windshield glass 103, enlarges the right-eye image 201R and the left-eye image 201L to desired virtual image sizes, and projects the enlarged images onto the windshield glass 103. The right-eye image 201R reaches the right-eye visual point 200R of the driver, and the left-eye image 201L reaches the left-eye image 201L of the driver.

From the visual point of the driver, on a virtual image position 202, a left-eye virtual image 202L is perceived from the left-eye visual point 200L, and a right-eye virtual image 202R is perceived from the right-eye visual point 200R. Since there is a parallax between the right-eye virtual image 202R and the left-eye virtual image 202L, the driver can visually recognize the stereoscopic image at a stereoscopic image perception position 203.

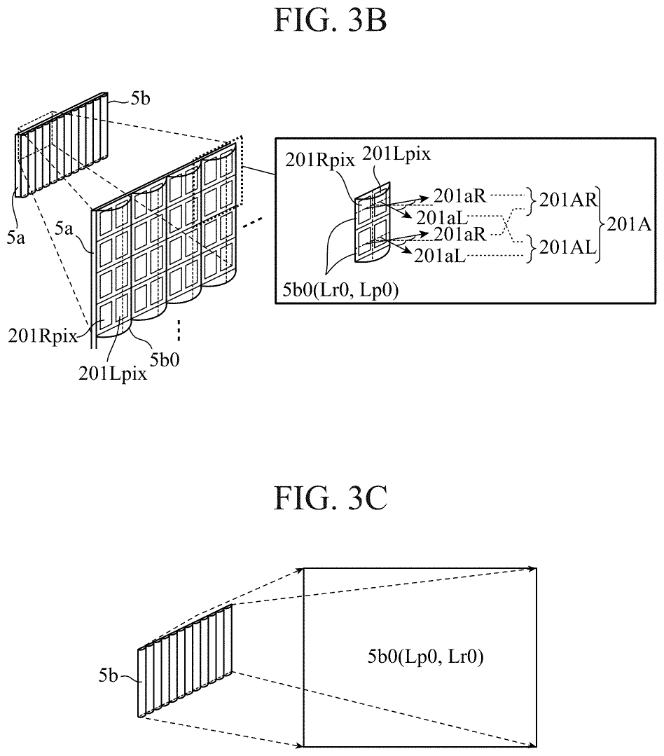

FIGS. 3A, 3B, and 3C are structural diagrams of a display unit 5a and an image separating unit 5b of a lenticular lens system that enables standard autostereoscopic vision. As illustrated in FIG. 3A, the image separating unit 5b is arranged in front of the display unit 5a. The standard image separating unit 5b is, for example, a lenticular lens in which a plurality of semicylindrical lenses, each having a radius of lens curvature Lr0 and a lens pitch Lp0 constant in the vertical direction, is arrayed in the horizontal direction.

As illustrated in FIG. 3B, the display unit 5a is arranged such that right-eye pixels 201Rpix and left-eye pixels 201Lpix are accommodated within the lens pitch Lp0. One right-eye pixel 201Rpix includes three subpixels of red, green, and blue (RGB). One left-eye pixel 201Lpix also includes three subpixels of red, green, and blue. The image generating unit 3 arrays the right-eye pixels 201Rpix and the left-eye pixels 201Lpix in the horizontal direction and thereby forms a stereoscopic image in the shape of horizontal stripes. When the display unit 5a is turned on, the right-eye pixels 201Rpix and the left-eye pixels 201Lpix are separated into right-eye pixels 201aR and left-eye pixels 201aL via the lens. All the pixels on the display unit 5a are separated by the image separating unit 5b to form a right-eye image visual recognition area 201AR and a left-eye image visual recognition area 201AL around the visual point position 200 of the driver. As a result, a stereoscopic visual recognition area 201A is formed. The position and the range of the stereoscopic visual recognition area 201A, that is, the width and the depth are determined by the radius of lens curvature Lr0 and the lens pitch Lp0 in agreement with the pixel pitch of the display unit 5a.

As illustrated in FIG. 3C, in the case where each lens 5b0 included in the lenticular lens of the image separating unit 5b has the same radius of lens curvature Lr0 and the same lens pitch Lp0, the area where the driver can visually recognize the stereoscopic image is limited to the stereoscopic visual recognition area 201A.

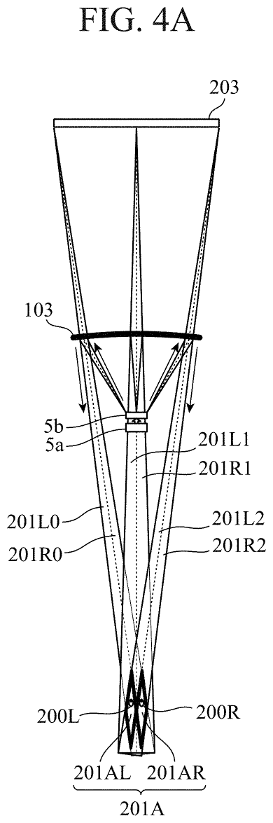

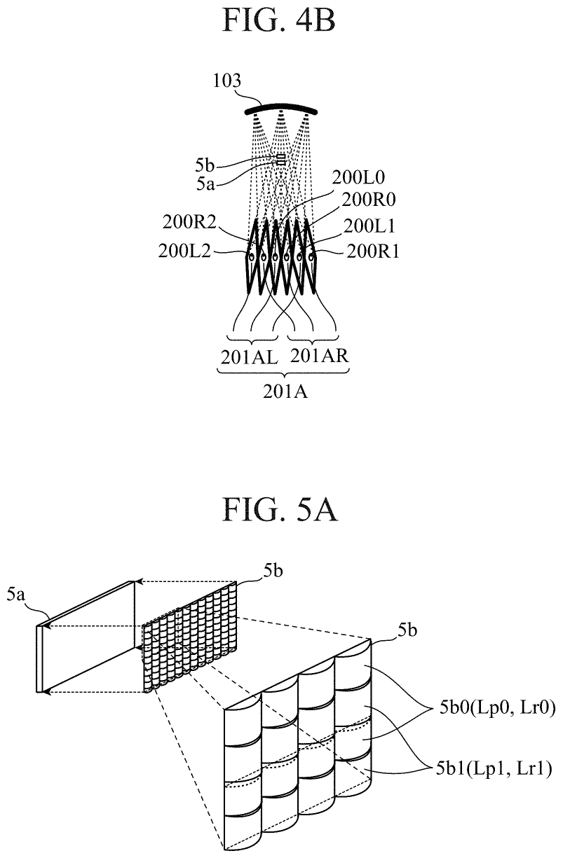

FIGS. 4A and 4B are diagrams illustrating a stereoscopic visual recognition area of a HUD utilizing standard binocular parallax. As illustrated in FIG. 4A, right-eye images 201R0, 201R1, and 201R2 and left-eye images 201L0, 201L1 and 201L2 separated by the image separating unit 5b are reflected by a windshield glass 103 and reach the right-eye visual point 200R and the left-eye visual point 200L of the driver, respectively. Specifically, the stereoscopic image output from the left end of the display unit 5a is separated by the image separating unit 5b and, as a left end left-eye image 201L0 and a left end right-eye image 201R0, reaches the visual point position 200 of the driver. The stereoscopic image output from the center of the display unit 5a is separated by the image separating unit 5b and, as a central right-eye image 201R1 and a central left-eye image 201L1 reach the visual point position 200 of the driver. The stereoscopic image output from the right end of the display unit 5a is separated by the image separating unit 5b and, as a right end right-eye image 201R2 and a right end left-eye image 201L2, reaches the visual point position 200 of the driver. Though not illustrated, the above similarly applies to stereoscopic images output from portions other than the left end, the center, and the right end of the display unit 5a.

At the left-eye visual point 200L of FIG. 4A, left-eye images on the display unit 5a such as the left end left-eye image 201L0, the central left-eye image 201L1, and the right end left-eye image 201L2 are gathered, thereby forming the left-eye image visual recognition area 201AL. Likewise, at the right-eye visual point 200R of FIG. 4A, right-eye images on the display unit 5a such as the left end right-eye image 201R0, the central right-eye image 201R1, and the right end right-eye image 201R2 are gathered, thereby forming the right-eye image visual recognition area 201AR. As a result, a stereoscopic visual recognition area 201A is formed. As described above, the left eye and the right eye of the driver enter the left-eye image recognition area 201AL and the right-eye image recognition area 201AR, respectively, and thus the driver can normally visually recognize the stereoscopic image at the stereoscopic image perception position 203. On the contrary, in the case where the left eye and the right eye of the driver deviate from the left-eye image recognition area 201AL and the right-eye image recognition area 201AR, respectively, the driver cannot normally visually recognize the stereoscopic image.

As illustrated in FIG. 4B, in the case of the lenticular lens system and a parallax barrier system which will be described later, right-eye image visual recognition areas 201AR and left-eye image visual recognition areas 201AL are repeatedly formed in the left-right direction. Therefore, even when the visual point position 200 of the driver moves to any one of right-eye visual points 200R0, 200R1, and 200R2 and left eye visual points 200L0, 200L1, and 200L2 in the left-right direction, the driver can visually recognize the stereoscopic image normally. In contrast, when the visual point position 200 of the driver moves to a position other than the right-eye visual points 200R0, 200R1, and 200R2 and the left-eye visual points 200L0, 200L1, and 200L2, crosstalk and the like occurs, which prevents the stereoscopic image from being normally, visually recognized.

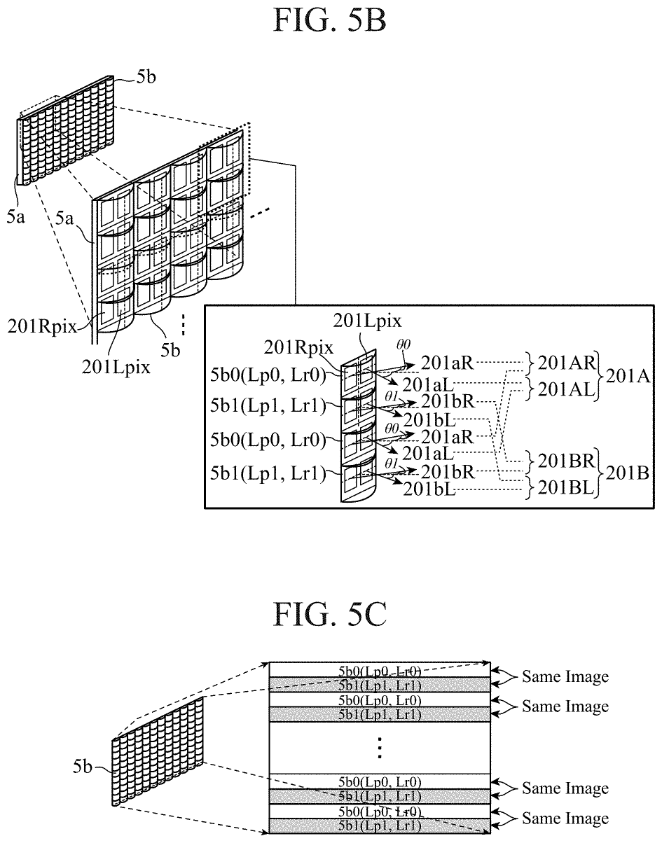

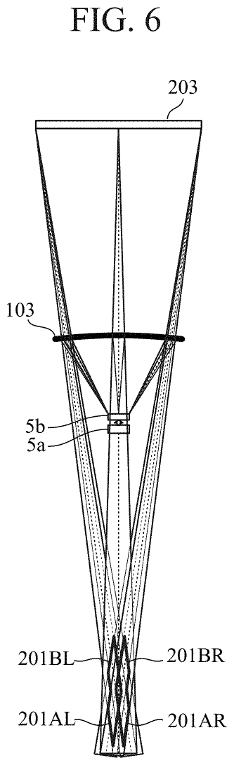

Next, the display unit 5a and the image separating unit 5b according, to the first embodiment of the present invention will be described. FIGS. 5A, 5B, and SC are structural diagrams of the display unit 5a and the image separating unit 5b of the stereoscopic display device 10 according to the first embodiment of the present invention. FIG. 6 is a diagram illustrating stereoscopic visual recognition areas 201A and 201B of the stereoscopic display device 10 according to the first embodiment of the present invention.

As illustrated in FIG. 5A, the image separating unit 5b according to the first embodiment includes two types of lenses, lenses 5b0 having a radius of lens curvature Lr0 and a lens pitch Lp0, and a lens 5b1 having a radius of lens curvature Lr1 and a lens pitch Lp1. In the vertical direction, the lenses 5b0 and 5b1 are periodically arrayed, and in the lateral direction, a plurality of lenses 5b0 is arrayed in odd rows and a plurality of lenses 5b1 is arrayed in even rows. Note that the lenses 5b0 and the lenses 5b1 are only required to have different radiuses of lens curvature, at least. The lenses 5b0 and the lenses 5b1 in the illustrated example have different radiuses of lens curvature of Lr0 and Lr1 but have the same lens pitches Lp0 and Lp1.

As illustrated in FIG. 5B, the display unit 5a is arranged such that right-eye pixels 201Rpix and left-eye pixels 201Lpix of the odd rows of the display unit 5a are accommodated in the lenses 5b0 and that right-eye pixels 201Rpix and left-eye pixels 201Lpix of the even rows of the display unit 5a are accommodated in the lenses 5b1. One right-eye pixel 201Rpix includes three subpixels of red, green, and blue. One left-eye pixel 201Lpix also includes three subpixels of red, green, and blue. The image generating unit 3 generates a stereoscopic image in which an image, in which the right-eye pixel 201Rpix and the left-eye pixel 201Lpix are periodically arrayed in the horizontal direction, is arrayed in every two rows in the vertical direction. That is, an image displayed on the display unit 5a corresponding to the lens 5b0 in the first row and an image displayed on the display unit 5a corresponding to the lens 5b1 in the second row are the same. An image displayed on the display unit 5a corresponding to the lens 5b0 in, the third row and an image displayed on the display unit 5a corresponding to 4b1 in the fourth row are the same. When the display unit 5a is turned on, the right-eye pixels 201Rpix and the left-eye pixels 201Lpix of the odd rows are separated into right-eye pixels 201aR and left-eye pixels 201aL at a separation angle of θ0 via the lenses 5b0. In addition, the right-eye pixels 201Rpix and the left-eye pixels 201Lpix of the even rows are separated into right-eye pixels 201bR and left-eye pixels 201bL at a separation angle of θ1 via the lenses 5b1.

As a result, the pixels in the odd rows on the display unit 5a are separated by the image separating unit 5b and form a stereoscopic visual recognition area 201A including a right-eye image visual recognition area 201AR and a left-eye image visual recognition area 201AL around the visual point position 200 of the driver. Likewise, the pixels in the odd rows on the display unit 5a are separated by the image separating, unit 5b and form a stereoscopic visual recognition area 201B including a right-eye image visual recognition area 201BR and a left-eye image visual recognition area 201BL around the visual point position 200 of the driver.

As illustrated in FIG. 5C, since the image separating unit 5b includes the lenses 5b0 having the radius of lens curvature Lr0 and the lens pitch Lp0 and the lenses 5b1 having the radius of lens curvature Lr1 and the lens pitch Lp1, the area where the driver can visually recognize the stereoscopic image includes two areas of the stereoscopic visual recognition area 201A and the stereoscopic visual recognition area 201B. Therefore, even when the visual point position 200 of the driver moves to either the stereoscopic visual recognition area 201A or the stereoscopic visual recognition area 201B, the driver can normally visually recognize the stereoscopic image.

Note that, also in the stereoscopic display device 10 according to the first embodiment, as illustrated in FIG. 4B, the stereoscopic visual recognition area 201A is repeatedly formed in the left-right direction. Likewise, the stereoscopic visual recognition area 201B is also repeatedly formed in the left-right direction.

As described above, the stereoscopic display device 10 according to the first embodiment includes the image generating unit 3, the display control unit 4, and the image separating unit 5b. The image generating unit 3 generates a stereoscopic image by arraying an image, in which a right-eye image and a left-eye image are periodically arrayed in the horizontal direction, in every two rows in the vertical direction perpendicular to the horizontal direction. The display control unit 4 causes the display unit 5a to display the stereoscopic image generated by the image generating unit 3. The image separating unit 5b separates the stereoscopic image displayed by the display unit 4a into right-eye images and left-eye images in the odd rows and right-eye images and left-eye images in the even rows at two separation angles of θ0 and θ1. As a result, the area where the stereoscopic image can be visually recognized is obtained as two areas of the stereoscopic visual recognition area 201A formed by the right-eye images and the left-eye images in the odd rows and the stereoscopic visual recognition area 201B formed by the right-eye images and the left-eye images in the even rows. In the related art, only one stereoscopic visual recognition area 201A is obtained, whereas in the first embodiment, the area is expanded to two stereoscopic visual recognition areas 201A and 201B, and thus even when the visual point position 200 of the driver moves, the stereoscopic image can be normally visually recognized.

The image separating unit 5b of the first embodiment is a lenticular lens in which two types of lenses 5b0 and 5b1 having different radiuses of lens curvature. Lr0 and Lr1 are periodically arrayed in the vertical direction Since the lenticular lens of the first embodiment only requires modification in the radius of lens curvature, the manufacturing cost does not increase as compared with the standard lenticular lens illustrated in FIGS. 3A, 3B, and 3C.

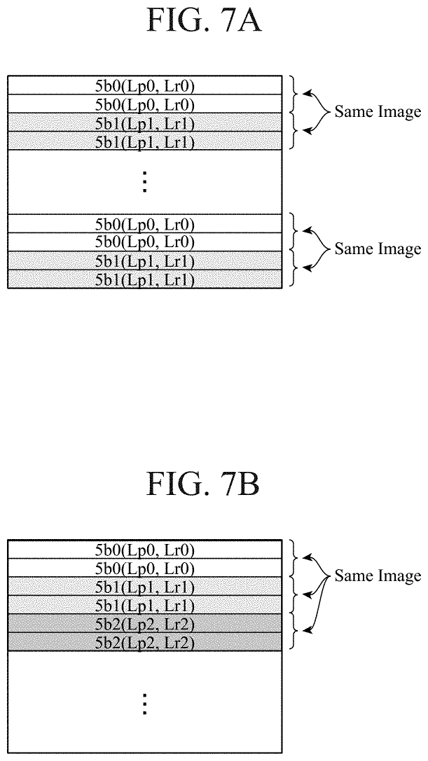

Note that the image separating unit 5b of the first embodiment includes two types of lenses 5b0 and 5b1 periodically arrayed row by row; however, the present invention is not limited thereto. For example, as illustrated in FIG. 7A, the image separating unit 5b may include two types of lenses 5b0 and 5b1 periodically arrayed alternately by every two rows. In this manner, the lenses 5b0 and 5b1 are only required to be periodically arranged alternately by every N rows, where N is an integer equal to or larger than one.

Although the image separating unit 5b of the first embodiment includes two types of lenses 5b0 and 5b1, the present invention is not limited to this structure. For example as illustrated in FIG. 7B, the image separating unit 5b may include three types of lenses 5b0, 5b1, and 5b2 periodically arrayed by every N rows. In this manner, the image separating unit 5b is only required to include n types of lenses periodically arrayed, where n is an integer equal to or larger than two. In this case, the image separating unit 5b separates the stereoscopic image displayed by the display unit 5a into n sets of right-eye images and left-eye images at n separation angles, and thus n stereoscopic visual recognition areas can be formed.

In the case of FIGS. 7A and 7B, the image generating unit 3 generates the stereoscopic image by arraying an image, in which a right-eye image and a left-eye image are periodically arrayed in the horizontal direction, by every n×N rows in the vertical direction.

In the image separating unit 5b according to the first embodiment, the lenses 5b0 and the lenses 5b1 arrayed in the horizontal direction are arrayed periodically in the vertical direction. However, contrarily, lenses 5b0 and lenses 5b1 arrayed in the vertical direction may be arrayed in the horizontal direction periodically. In this configuration, the image generating unit 3 generates a stereoscopic image by arraying an image, in which a right-eye image and a left-eye image are periodically arrayed in the vertical direction, is arrayed by every two rows in the horizontal direction.

In the first embodiment, the image display unit 5 includes the reflection glass 5c, and the reflection glass 5c projects the stereoscopic image onto the windshield glass 103 to cause the driver to visually recognize the stereoscopic image. However, in the case of a stereoscopic display device 10 of a direct viewing type, the windshield glass 103 and the reflection glass 5c are not necessarily included.

The image display unit 5 may further include a driving mechanism for vertically moving the reflection glass 5c. The image display unit 5 controls the driving mechanism such that the position of the reflection glass 5c moves vertically depending, on the physique of the driver. In the case where the visual point position 200 of the driver is high, the position at which the stereoscopic image is projected on the windshield glass 103 rises. Conversely, in the case where the visual point position 200 is low, the position at which the stereoscopic image is projected on the windshield glass 103 is lowered. Thus, the position of the stereoscopic visual recognition area can be adjusted depending on the visual point position 200 of the driver in the vertical direction. Note that the image display unit 5 can acquire information of the visual point position 200 from the position information acquiring unit 10.

In the first embodiment, the image generating unit 3 generates the right-eye image and the left-eye image; however, the present invention is not limited thereto. The image generating unit 3 may acquire a right-eye image and a left-eye image generated outside the stereoscopic display device 10 via the in-vehicle network 102. The image generating unit 3 generates a stereoscopic image from the acquired right-eye image and the left-eye image.

### Second Embodiment

The display control unit 4 of the first embodiment is configured to turn on all the pixels of the display unit 5a. Contrary to this, a display control unit 4 of a second embodiment selectively turns on either one of pixels corresponding to a stereoscopic visual recognition area 201A and pixels corresponding to a stereoscopic visual recognition area 201B on a display unit 5a and turns off the other depending on a visual point position 200 of a driver.

Note that a configuration of a stereoscopic display device 10 according to the second embodiment is the same in the drawing as the configuration of the stereoscopic display device 10 according to the first embodiment illustrated in FIGS. 1 to 7, and thus FIGS. 1 to 7 are referred to in the following description.

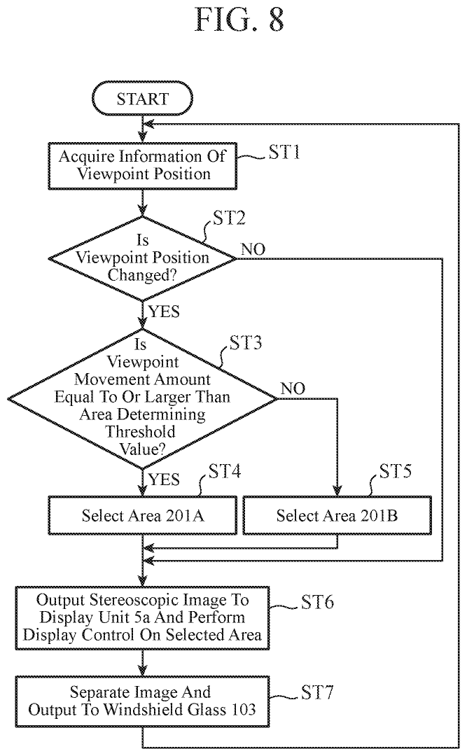

FIG. 8 is a flowchart illustrating exemplary operation of the stereoscopic display device 10 according to the second embodiment of the invention. It is assumed that an image generating unit 3 generates a stereoscopic image on the basis of vehicle information acquired by a vehicle information acquiring unit 2 in parallel with the flowchart of FIG. 8.

In step ST1, a position information acquiring unit 1 acquires position information indicating a visual point position 200 of a driver from an onboard camera 101 and outputs the position information to the display control unit 4.

In step ST2, the display control unit 4 compares visual point position 200 indicated by previously acquired position information with the visual point position 200 indicated by the position information acquired at this time. If the current visual point position 200 has been changed from the previous visual point position 200 (step ST2 “YES”), the display control unit 4 proceeds to step ST3, and if not (step ST2 “NO”), the display control unit 4 proceeds to step ST6.

In step ST3, the display control unit 4 compares a visual point movement amount 2201) with an area determining threshold value Dth. If the visual point movement amount 220D is equal to or larger than the area determining threshold value Dth (step ST3 “YES”), the display control unit 4 proceeds to step ST4, If the visual point movement amount 220D is less than the area determining threshold value Dth (step ST3 “NO”), the display control unit 4 proceeds to step ST5.

In step ST4, the display control unit 4 selects the stereoscopic visual recognition area 201A since the visual point movement amount 220D is equal to or larger than the area determining threshold value Dth.

In step ST5, the display control unit 4 selects the stereoscopic visual recognition area 201B since the visual point movement amount 220D is less than the area determining threshold value Dth.

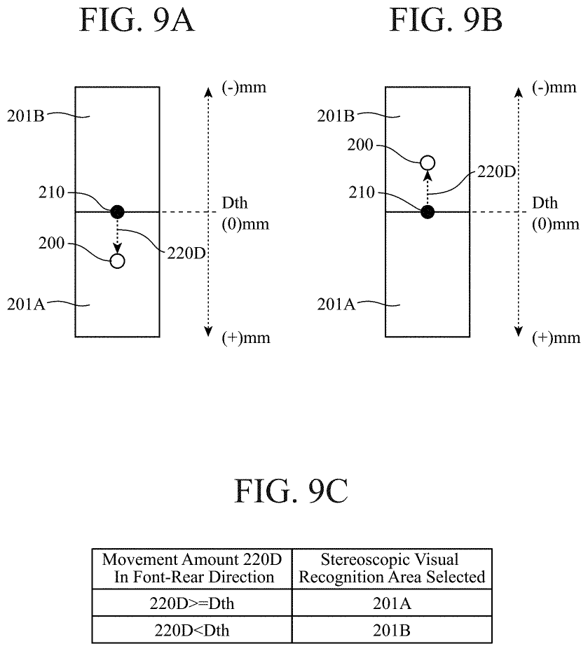

FIGS. 9A, 9B, and 9C are diagrams and a table for explaining the operation of the display control unit 4 of the second embodiment of the present invention. As illustrated in FIGS. 9A and 9B, the visual point movement amount 2201) is not a movement amount from the previous visual point position 200 to the current visual point position 200 but is a movement amount in the front-rear direction from an eye box center 210 of the driver to the current visual point position 200. The eye box center 210 of the driver s a position at which the visual point position 200 is assumed to be present when the driver is seated on the driver's seat, which is a value given to the display control unit 4 in advance. The area determining threshold value Dth is a threshold value for determining in which of the stereoscopic visual recognition areas 201A and 201B the visual point position 200 of the driver is positioned, and is given to the display control unit 4 in advance. In the illustrated example, “0 mm” which is the eye box center 210 is set as the area determining threshold value 13th. The “−” side indicates the front side, that is, the windshield glass 103 side, and the “+” side indicates the rear side, that is, the rear glass side.

As illustrated in FIGS. 9A and 9C, when the visual point position 200 is at the eye box center 210 or is on the “+” side with respect to the eye box center 210, the display control unit 4 selects the stereoscopic visual recognition area 201A.

As illustrated in FIGS. 9B and 9C, when the visual point position 200 is on the “−” side with respect to the eye box center 210, the display control unit 4 selects the stereoscopic visual recognition area 201B.

In step ST6, the display control unit 4 causes the display unit 5a to display the stereoscopic image generated by the image generating unit 3. At that time, the display control unit 4 controls the display unit 5a to turn on pixels corresponding to the stereoscopic visual recognition area selected in step ST4 or step ST5 in the stereoscopic image and to turn off other pixels.

For example, let us consider a case where the image separating unit 5b includes a lens 5b0 for the stereoscopic visual recognition area 201A and a lens 5b1 for the stereoscopic visual recognition area 201B arranged row by row in the shape of horizontal stripes as illustrated in FIG. 5C. In this structure, in the case where the stereoscopic visual recognition area 201A is selected, the display control unit 4 turns on the pixels corresponding to the stereoscopic visual recognition area 201A and turns off the pixels corresponding to the stereoscopic visual recognition area 201B. That is, the display control unit 4 causes the display unit 5a to display the right-eye image and the left-eye image of only the odd rows in the stereoscopic image. On the other hand, in the case where the stereoscopic visual recognition area 201B is selected, the display control unit 4 turns off the pixels corresponding to the stereoscopic visual recognition area 201A and turns on the pixels corresponding to the stereoscopic visual recognition area 201B. That is, the display control unit 4 causes the display unit 5a to display the right-eye image and the left-eye image of only the even rows in the stereoscopic image.

In step ST7, the image separating unit 5b separates one of the images corresponding to the stereoscopic visual recognition area 201A and the stereoscopic visual recognition area 201B displayed by the display unit 5a into a right-eye image and a left-eye image and projects the separated images onto the windshield glass 103.

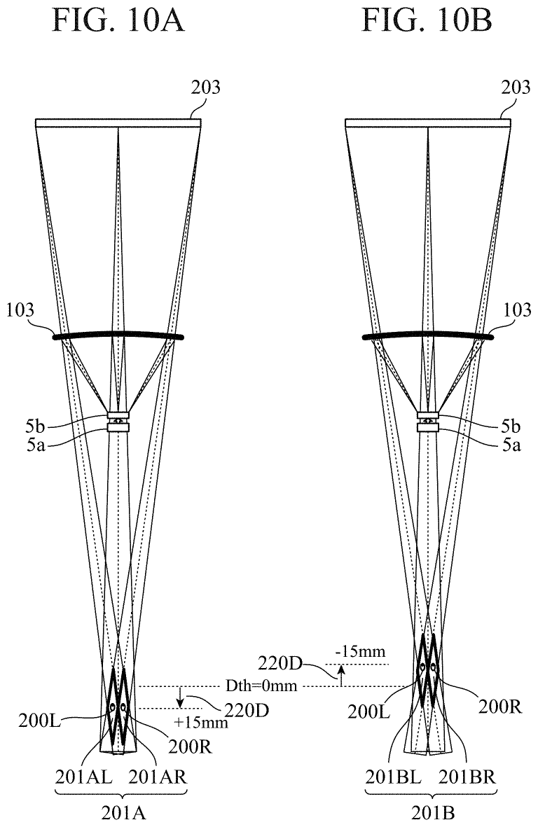

FIG. 10A and FIG. 10B are diagrams for explaining the relationship between the visual point position 200 and the stereoscopic visual recognition areas 201A and 201B according to the second embodiment of the present invention. Here, it is assumed that the area determining threshold value Dth is “0 mm”. When the current visual point position 200 obtained from the position information acquiring unit 1 is moved by “+15 mm” from the eye box center 210, since the visual point movement amount 220D is equal to or greater than “0 mm,” the display control unit 4 controls the display of the stereoscopic image by the display unit 5a such that the stereoscopic visual recognition area 201A is formed. On the other hand, when the current visual point position 200 obtained from the position information acquiring unit 1 is moved by “−15 mm” from the eye box center 210, since the visual point movement amount 2201) is less than “0 mm,” the display control unit 4 controls the display of the stereoscopic image by the display unit 5a such that the stereoscopic visual recognition area 201B is formed.

As described above, the stereoscopic display device 10 according to the second embodiment includes the position information acquiring unit 1 that acquires position information in the front-rear direction of the driver. The display control unit 4 according to the second embodiment selects, on the basis of the position information acquired by the position information acquiring unit 1, one of every two images, which are arrayed in the vertical direction in the stereoscopic image in every two rows and causes the display unit 5a to display the selected images. With this configuration, in the case where the stereoscopic visual recognition area 201A and the stereoscopic visual recognition area 201B partially overlap with each other, even when the visual point position 200 of the driver moves to the overlapping portion, no crosstalk occurs, thus allowing the driver to normally visually recognize the stereoscopic image.

Note that although in the second embodiment the example of switching between the stereoscopic visual recognition area 201A and the stereoscopic visual recognition area 201B has been illustrated, the display control unit 4 can switch three or more stereoscopic visual recognition areas. For example, as illustrated in FIG. 7B, in the case where n (=3) types of lenses 5b0, 5b1, and 5b2 are periodically arrayed in the image separating unit 5b, a stereoscopic image is generated in which an image, in which a right-eye image and a left-eye image are periodically arrayed in the horizontal direction, is arrayed, in every n×N (=3×2) rows in the vertical direction. The display control unit 4 switches to one of stereoscopic visual recognition areas 201A, 201B, and 201C (not illustrated) by using two area determining threshold values Dth having different values. When switching to the stereoscopic visual recognition area 201A, the display control unit 4 controls the display unit 5a to turn on images for the lenses 5b0 of the first two rows out of every six rows in the stereoscopic image and to turn off images for the lenses 5b1 and 5b2 of the remaining every four rows. When switching to the stereoscopic visual recognition area 201B, the display control unit 4 controls the display unit 5a to turn on images for the lenses 5b1 of the two rows in the center out of every six rows in the stereoscopic image and to turn off images for the lenses 5b0 and 5b2 of the remaining every four rows. When switching to the stereoscopic visual recognition area 201C, the display control unit 4 controls the display unit 5a to turn on images for the lenses 5b2 of the last two rows out of every six rows in the stereoscopic image and to turn off images for the lenses 5b0 and 5b1 of the remaining every four rows.

### Third Embodiment

In the first and second embodiments, the image separating unit 5b includes two types of lenses 5b0 and 5b1 and thereby forms two stereoscopic visual recognition areas of the stereoscopic visual recognition area 201A and the stereoscopic visual recognition area 201B in the front-rear direction. Contrary to this, in a third embodiment, a plurality of stereoscopic visual recognition areas is formed not only in the front-rear direction but also in the left-right direction.

Note that a configuration of a stereoscopic display device 10 according to the third embodiment is the same in the drawing as the configuration of the stereoscopic display devices 10 according to the first and second embodiments illustrated in FIGS. 1 to 10, and thus FIGS. 1 to 10 are referred to in the following description.

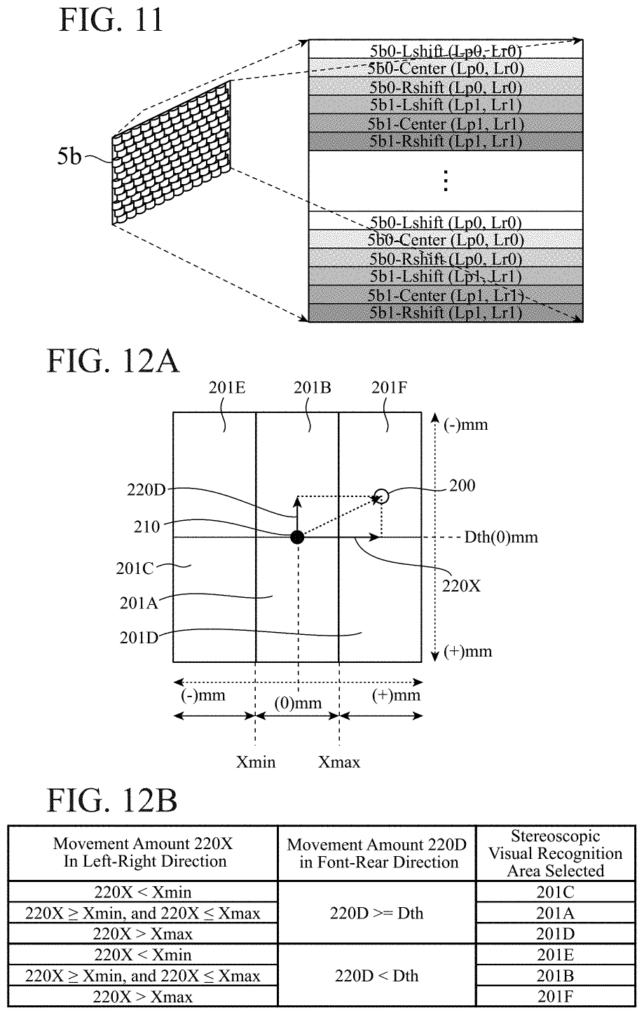

FIG. 11 is a structural diagram of an image separating unit 5b of a stereoscopic display device 10 according to the third embodiment of the present invention. The image separating unit 5b includes six types of lenses, namely, a lens 5b0-Center, a lens 5b0-Rshift, a lens 5b0-Lshift, a lens 5b1-Center, a lens 5b1-Rshift, and a lens 5b1-Lshift. The lens 5b0-Center, the lens 5b0-Rshift, and the lens 5b0-Lshift have the same radius of lens curvature Lr0 and the same lens pitch Lp0. In addition, the lens 5b1-Center, the lens 5b1-Rshift, and the lens 5b1-Lshift have the same radius of lens curvature Lr1 and the same lens pitch Lp1. Each of the lenses is arrayed in a horizontal row. Note that the lenses 5b0-Rshift and 5b1-Rshift are arranged with the lens center shifted to the right with respect to the lenses 5b0-Center and 5b1-Center, respectively. In addition, the lenses 5b0-Lshift and 5b1-Lshift are arranged with the lens center shifted to the left with respect to the lenses 5b0-Center and 5b1-Center, respectively.

FIGS. 12A and 12B are a diagram and a table for explaining the operation of a display control unit 4 of the third embodiment of the present invention. As illustrated in FIG. 11, since the image separating unit 5b of the third embodiment includes the six types of lenses, a total of six stereoscopic visual recognition areas 201A, 201B, 201C, 201D, 201E, and 201F in three front directions of the front left, the front center, the front right and in three rear directions of the rear left, the rear center, and the rear right are formed as illustrated in FIG. 12A. Here, the stereoscopic visual recognition area 201A in the rear center is formed by the lens 5b0-Center, the stereoscopic visual recognition area 201C in the rear left is formed by the lens 5b0-Lshift, and the stereoscopic visual recognition area 201D in the rear right is formed by the lens 5b0-Rshift. The stereoscopic visual recognition area 201B in the front center is formed by the lens 5b1-Center, the stereoscopic visual recognition area 201E in the front left is formed by the lens 5b1-Lshift, and the stereoscopic, visual recognition area 201F in the front right is formed by the lens 5b1-Rshift.

The image generating unit 3 of the third embodiment generates a stereoscopic image in which an image, in which a right-eye pixel 201Rpix and a left-eye pixel 201Lpix are periodically arrayed in the horizontal direction, is arrayed in every six rows in the vertical direction. That is, an image displayed on a display unit 5a corresponding to the lens 5b0-Lshift in the first row, an image displayed on the display unit 5a corresponding to the lens 5b0-Center in the second row, an image displayed on the display unit 5a corresponding to the lens 5b0-Rshift in the third row, an image displayed on the display unit 5a corresponding to the lens 5b1-Lshift in the fourth row, an image displayed on the display unit 5a corresponding to the lens 5b1-Center in the fifth row, and an image displayed on the display unit 5a corresponding to the lens 5b1-Rshift in the sixth row are all the same.

The display control unit 4 according to the third embodiment sets the optimum stereoscopic visual recognition area from among the six stereoscopic visual recognition areas on the basis of position information of a visual point position 200 of a driver in the front-rear and the left-right directions. Then, the display control unit 4 controls the display unit 5a to turn on pixels corresponding to the stereoscopic visual recognition area having been set in the stereoscopic image generated by an image generating unit 3 and to turn off other pixels.

As illustrated in FIG. 12A and FIG. 12B, a visual point movement amount 220D is a movement amount in the front-rear direction from an eye box center 210 of the driver to the visual point position 200 currently acquired. An area determining threshold value Dth is a threshold value for determining in which of the stereoscopic visual recognition areas 201B, 201E, and 201F in the front direction and the stereoscopic visual recognition areas 201A, 201C, and 201D in the rear direction the visual point position 200 of the driver is positioned, and is given to the display control unit 4 in advance. In the illustrated example, “0 mm” which is the eye box center 210 is given as the area determining threshold value Dth.

On the other hand, a visual point movement amount 220X is the movement amount in the left-right direction from the eye box center 210 to the visual point position 200 acquired this time. An area determining threshold value Xmax is a threshold value for determining in which of the stereoscopic visual recognition areas 201D and 201F in the right direction and the stereoscopic visual recognition areas 201A and 201B in the center direction the visual point position 200 of the driver is positioned, and is given to the display control unit 4 in advance. An area determining threshold value Xmin is a threshold value for determining in which of the stereoscopic visual recognition areas 201C and 201E in the left direction and the stereoscopic visual recognition areas 201A and 201B in the center direction the visual point position 200 of the driver is positioned, and is given to the display control unit 4 in advance. With “0 mm” at the eye box center 210 using as a reference, “+30 mm” is set to the area determining threshold value Xmax, and “−30 mm” is set to the area determining threshold value Xmin.

The display control unit 4 compares the area determining threshold value Dth in the front-rear direction and the visual point movement amount 220D in the front-rear direction. The display control unit 4 also compares the area determining threshold values Xmax and Xmin in the left-right direction with the visual point movement amount 220X in the left-right direction. From these comparison results, the display control unit 4 selects any one of the stereoscopic visual recognition areas 201A to 201F as a stereoscopic visual recognition area as illustrated in FIG. 12B.

In FIG. 12A, the current visual point position 200 obtained from a position information acquiring unit 1 is a position moved from the eye box center 210 by “−20 mm” in the front-rear direction and by “+40 mm” in the left-right direction. Since the visual point movement amount 220D of “−20 mm” in the front-rear direction is less than the area determining threshold value Dth “0 mm,” the selection result of stereoscopic visual recognition area is any one of the stereoscopic visual recognition, areas 201E, 201B, and 201F. Furthermore, since the visual point movement amount 220X of “+40 mm” in the left-right direction is equal to or larger than the area determining threshold value Xmax “+30 mm,” the stereoscopic visual recognition area 201F is selected from the stereoscopic visual recognition areas 201E, 201B, and 201F. The display control unit 4 causes the display unit 5a to display right-eye images and left-eye images corresponding to the lens 5b1-Rshift so that the stereoscopic visual recognition area 201F is formed.

As described above, the stereoscopic display device 10 according to the third embodiment includes the position information acquiring unit 1 that acquires position information in the front-rear direction and the left-right direction of the driver. The display control unit 4 according to the third embodiment selects, on the basis of the position information acquired by the position information acquiring unit 1, one of every six images, which are arrayed in the vertical direction in the stereoscopic image in every six rows and causes the display unit 5a to display the selected images. With this configuration, the stereoscopic visual recognition area can be expanded not only in the front-rear direction but also in the left-right direction. Therefore, even when the visual point, position 200 of the driver moves, the stereoscopic image can be normally visually recognized.

Note that the display control unit 4 of the third embodiment divides the front-rear direction into two stereoscopic visual recognition areas and further divides the left-right direction into three stereoscopic visual recognition areas to divide into a total of six areas, and selects the optimum stereoscopic visual recognition area by comparing the visual point movement amounts 220D and 220X from the eye box center 210 of the driver to the visual point position 200 with the area determining threshold values Dth, Xmax, and Xmin; however, the present invention is not limited to this configuration.

As described with reference to FIG. 4B, the right-eye image visual recognition area 201AR and the left-eye image visual recognition area 201AL are repeatedly formed in the left-right direction. When the right-eye visual point 200R0 moves to the left-eye image visual recognition area 201AL and the left-eye visual point 200L0 moves to the right-eye image visual recognition area 201AR, projecting the right-eye image to the left-eye image visual recognition area 201AL and projecting the left-eye image to the right-eye image visual recognition area 201AR allows the driver to normally visually recognize the stereoscopic image. Therefore, the image generating unit 3 may generate a normal stereoscopic image as well as a stereoscopic image in which the right-eye image and the left-eye image are switched, and the display control unit 4 may switch whether to display the normal stereoscopic image or to display the stereoscopic image in which the right-eye image and the left-eye image are switched on the basis of the visual point movement amount in the left-right direction. As a result, the number of the types of lenses included in the image separating unit 5b can be reduced.

Meanwhile, as described with reference to FIG. 4B, when the right-eye visual point 200R0 moves from the right-eye image visual recognition area 201AR to the adjacent right-eye image visual recognition area 201AR and the left-eye visual point 200L0 moves from the left-eye image visual recognition area 201AL to the adjacent left-eye image recognition area 201AL, the driver can still normally visually recognize the stereoscopic image without switching the stereoscopic visual recognition area 201A to the adjacent stereoscopic visual recognition area 201C or 201D but keeping the stereoscopic visual recognition area 201A. Therefore, the display control unit 4 may determine whether to switch from the stereoscopic visual recognition areas 201A and 201B to the adjacent stereoscopic visual recognition areas 201C to 201F or to keep the stereoscopic visual recognition areas 201A and 201B on the basis of the visual point movement amount in the left-right direction and control the display on the display unit 5a depending on the determination result.

The image separating unit 5b according to the third embodiment divides the front-rear direction into two stereoscopic visual recognition areas and further divides the left-right direction into three stereoscopic visual recognition areas to divide into a total of six areas; however, the present invention is not limited to this configuration, and division may be performed to obtain any number of stereoscopic visual recognition areas other than six areas.

Moreover, the display control unit 4 of the second and third embodiments control the display of the display unit 5a on the basis of information of the visual point position 200 acquired from the onboard camera 101 by the position information acquiring unit 1; however, this is not limited to the information of the visual point position 200. The display control unit 4 may control the display of the display unit 5a for example on the basis of information from a switch or the like for switching the stereoscopic visual recognition areas 201A to 201E by the operation by the driver.

### Fourth Embodiment

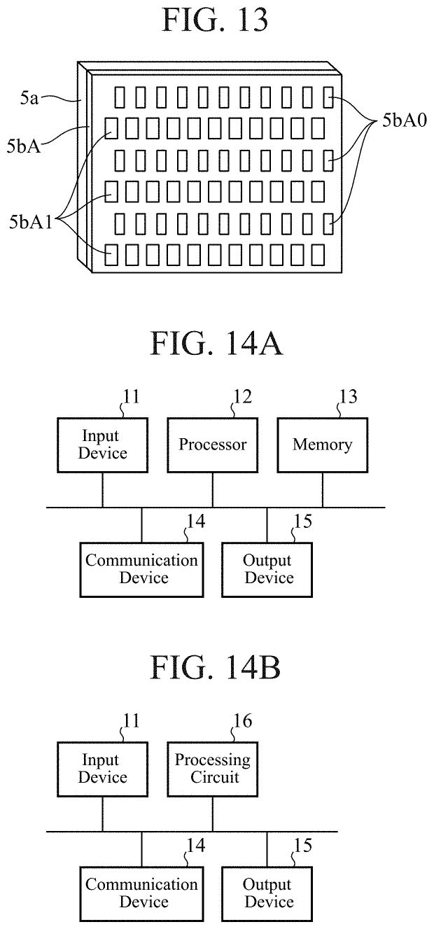

Although the image separating unit 5b of the first to third embodiments is a lenticular lens, the present invention is not limited thereto, and a parallax barrier may be employed. FIG. 13 is a structural diagram of an image separating unit 5bA including a parallax barrier in a stereoscopic display device 10 according to a fourth embodiment of the present invention. The image separating unit 5bA includes two types of slits having different widths. In the vertical direction, a slit 5bA0 and a slit 5bA1 are periodically arrayed, and in the horizontal direction, a plurality of slits 5bA0 is arrayed in odd rows and a plurality of slits 5bA1 is arrayed in even rows. The slit 5bA0 has the same function as the lens 5b0 in FIGS. 5A, 5B, and 5C, and the slit 5bA1 has the same function as the lens 5b1. Since configurations of the stereoscopic display device 10 other than the image separating unit 5bA are as described in the first to third embodiments, description thereof will be omitted here.

As described above, the image separating unit 5bA of the fourth embodiment is a parallax barrier n which n types of slits 5bA0 and 5bA1 having different widths is periodically arrayed. Also in this configuration, effects similar to those of the first to third embodiments can be obtained.

Finally, hardware configuration examples of the stereoscopic display devices 10 according to the first to fourth embodiments of the present invention will be described. FIG. 14A and FIG. 14B are main hardware configuration diagrams of the stereoscopic display devices and peripheral devices thereof according to the respective embodiments of the present invention. The functions of the position information acquiring unit 1 the image generating unit 3, and the display control unit 4 in the stereoscopic display device 10 are implemented by a processing circuit. That is, the stereoscopic display device 10 includes a processing circuit for implementing the above functions. The processing circuit may be a processor 12 that executes a program stored in a memory 13 or a processing circuit 16 as dedicated hardware.

As illustrated in FIG. 14A, in the case where the processing circuit is the processor 12, the respective functions of the position information acquiring unit 1, the image generating unit 3, and the display control unit 4 are implemented by software, firmware, or a combination of software and firmware. Software and firmware are described as a program and stored in the memory 13. The processor 12 reads and executes the program stored in the memory 13 and thereby implements the functions of the respective units. That is, the stereoscopic display device 10 includes the memory 13 for storing the program, execution of which by the processor 12 results in execution of the steps illustrated in the flowchart of FIG. 8. It can also be said that this program causes a computer to execute the procedures or methods of the position information acquiring unit 1, the image generating unit 3, and the display control unit 4.

In the case where the processing circuit is dedicated hardware as illustrated in FIG. 14B, the processing circuit 16 corresponds to, for example, a single circuit, a composite circuit, a programmed processor, a parallel programmed processor, an application specific integrated circuit (ASIC), a field-programmable gate array (FPGA), or a combination thereof. The functions of the position information acquiring unit 1, the image generating unit 3, and the display control unit 4 may be implemented by a plurality of processing circuits 16. Alternatively, the functions of the respective units may be collectively implemented by the processing circuit 16.

In this embodiment, the processor 12 may be a central processing unit (CPU), a processing device, a computing device, a microprocessor, a microcomputer, or the like.

The memory 13 may be a nonvolatile or volatile semiconductor memory such as a random access memory (RAM), a read only memory (ROM), an erasable programmable ROM (EPROM), or a flash memory a magnetic disk such as a hard disk or a flexible disk, or an optical disk such as a compact disc (CD) or a digital versatile disc (DVD).

Note that some of the functions of the position information acquiring unit 1, the image generating unit 3, and the display control unit 4 may be implemented by dedicated hardware and some are implemented by software or firmware. In this manner, the processing circuit in the stereoscopic display device 10 can implement the above functions by hardware, software, firmware, or a combination thereof.

An input device 11 corresponds to the onboard camera 101, a switch, or the like and inputs the position information, of the driver to the stereoscopic display device 10. A communication device 14 corresponds to the vehicle information acquiring unit 2 and acquires vehicle information from an ECU mounted on the vehicle 100 via the in-vehicle network 102. An output device 15 corresponds to a liquid crystal display or the like which is the display unit 5a, a lenticular lens or a parallax barrier which is the image separating unit 5b or 5bA, respectively, and the windshield glass 103 or a combiner.

Note that, within the scope of the present invention, the present invention may include a flexible combination of the respective embodiments, a modification of any component of the respective embodiments, or omission of any component in the respective embodiments.

In the above description, the example in which the stereoscopic display device 10 is mounted on the vehicle 100 has been described however, the stereoscopic display device 10 may also be used in some device other than the vehicle 100. In that case, the position information acquiring unit 1 acquires information of a visual point, position of an observer who uses the stereoscopic display device 10.

### INDUSTRIAL APPLICABILITY

A stereoscopic display device according to the present invention is suitable as a stereoscopic display device used in an onboard HUD or the like since the area where a stereoscopic image can be visually recognized is expanded as compared with a standard lenticular lens system or a parallax barrier system.

### REFERENCE SIGNS LIST

1 Position information acquiring unit
2 Vehicle information acquiring unit
3 Image generating unit
4 Display control unit
5 Image display unit
5a Display unit
5b, 5bA Image separating unit
5b0, 5b0-Center, 5b0-Rshift, 5b0-Lshift, 5b1, 5b1-Center, 5b1-Rshift, 5b1-Lshift, 5b2 lens
5bA0, 5bA1 Slit
5c Reflection glass
10 Stereoscopic display device
11 Input device
12 Processor
13 Memory
14 Communication device
15 Output device
16 Processing circuit
100 Vehicle
101 Onboard camera
102 In-vehicle network
103 Windshield glass
200 Visual point position
200L, 200L0 to 200L2 Left-eye visual point
200R, 200R0 to 200R2 Right-eye visual point
201A to 201F Stereoscopic visual recognition area
201AL, 201BL Left-eye image visual recognition area
201AR, 201BR Right-eye image visual recognition area
201aL, 201bL, 201Lpix Left-eye pixel
201L Left-eye image
201aR, 201bR, 201Rpix Right-eye pixel
201R Right-eye image
202 Virtual image position
202L Left-eye virtual image
202R Right-eye virtual image
203 Stereoscopic image perception position
210 Eye box center
220D, 220X Visual point movement amount
Dth, Xmax, Xmin Area determining threshold value
Lp0 Lens pitch
Lr0 Radius of lens curvature
θ0, θ1 Separation angle

1. A stereoscopic display device comprising:
a processor; and
a memory storing instructions which, when executed by the processor, causes the processor to perform processes of:
forming first image groups, each of which includes at least one right-eye image and at least one left-eye image periodically arrayed in one direction, forming a second image group by arraying the first image groups in every n rows in a direction orthogonal to the one direction, where n is an integer equal to or larger than two, and generating a stereoscopic image;
causing a display unit to display the generated stereoscopic image; and
separating the stereoscopic image displayed by the display unit into n sets of right-eye images and left-eye images at n separation angles.

2. The stereoscopic display device according to claim 1,
wherein the processor causes the display unit to display any one of the n pieces of first image groups each arrayed in the orthogonal direction in the stereoscopic image and included in the second image group.

3. The stereoscopic display device according to claim 2,
wherein the processes further comprise: acquiring position information of an observer in a front-rear direction or a left-right direction,
wherein the processor selects any one of the n pieces of first image groups each arrayed in the orthogonal direction in the stereoscopic image and included in the second image group on the basis of the acquired position information and causes the display unit to display the selected first image group.

4. The stereoscopic display device according to claim 1, wherein the process for separating the stereoscopic image includes a lenticular lens in which n types of lenses having different radiuses of lens curvature are periodically arrayed in the orthogonal direction.

5. The stereoscopic display device according to claim 1, wherein the process for separating the stereoscopic image includes a parallax barrier in which n types of slits having different widths are periodically arrayed in the orthogonal direction.

6. A head-up display comprising the stereoscopic display device according to claim 1.
